(19) United States
(12) Patent Application Publication
(10) Pub. No.: US 2008/0229252 A1
(43) Pub. Date: Sep. 18, 2008

(54) APPARATUS AND METHOD OF MANAGING DATA

(75) Inventor: In-chul Hwang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/846,891

(22) Filed: Aug. 29, 2007

(30) Foreign Application Priority Data
Mar. 16, 2007 (KR) 10-2007-0026069

(51) Int. Cl. G06F 3/048

(52) U.S. Cl. 715/854

(57) ABSTRACT

Provided are an apparatus and method of managing data that is capable of receiving and storing in advance, when constructing a menu screen using data received through a network, data from a convertible menu screen on the basis of a currently displayed menu screen and constructing the menu screen using the data stored at the time of selecting the corresponding menu screen. The apparatus includes a control unit which confirms that a first page being displayed can be converted into a second page based on the first page, a data searching unit which determines whether data of the second page is stored, and a transceiver which the data if it is determined that the data is not stored.

### CROSS REFERENCE TO RELATED APPLICATION

This application claims priority from Korean Patent Application No. 10-2007-0026069, filed on Mar. 16, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to managing data, and more particularly, to an apparatus and method of managing data that are capable of receiving and storing in advance, when constructing a menu screen using data received through a network, data from a convertible menu screen on the basis of a currently displayed menu screen and constructing the menu screen using the data stored at the time of selecting the corresponding menu screen.

2. Description of the Related Art

A hyperlink is used to convert a part of a current Web document into other contents according to a selection of a user on a text or an image displayed on a screen, or to convert the current Web document into another Web document. That is, the user selects a specific region from the Web document currently displayed to allow another Web page, which the user desires to view, to be displayed.

Hyperlinks have become a basis of the World Wide Web, which is not limited to Hyper Text Mark-up Language (HTML) or the Web.

With the development of an integration technology, various types of portable apparatuses have been developed. Portable apparatuses are classified into apparatuses that place emphasis on a specific function and apparatuses that place emphasis on a complex function.

In particular, with the development of a communication technology, the types of portable apparatuses have increased. For example, a cellular phone provides a function for providing a communication between users and a function for providing an Internet service. In this case, in order to provide the Internet service to the user, the portable apparatus may use a wireless communication. As well known, since the wireless communication performs communication using a limited bandwidth as compared with a wire communication, data may not be exchanged securely.

A hyperlink serves to update a part of a current screen or the entire current screen to a new screen when the user selects items displayed on a screen, such as text or images. In this case, the portion of the screen or the entire screen, which is necessary for updating the screen, needs to be received by communication. At this time, in the case of the wire communication in which a relatively high bandwidth is ensured, the hyperlink may be securely performed. In the case of wireless communication in which a relatively low bandwidth is ensured, the hyperlink may not be performed securely.

Further, even in the case of the wire communication, when converting a currently displayed screen into another screen, a time delay occurs at the time of receiving data of another screen. The time delay varies according to a network state. As a result, an inconsistent service may be provided to the user according to the network state.

Accordingly, it is required to minimize the amount of time delayed when converting a screen according to the selection of the user.

### SUMMARY OF THE INVENTION

The present invention provides an apparatus and method of managing data that is capable of receiving and storing in advance, when constructing a menu screen using data received through a network, data from a convertible menu screen on the basis of a currently displayed menu screen and constructing the menu screen using the data stored at the time of selecting the corresponding menu screen.

According to an aspect of the present invention, there is provided an apparatus for managing data, the apparatus including a control unit confirming a second page that is movable on the basis of a first page being displayed, a data searching unit confirming whether data of the second page is stored, and a transceiver receiving the data according to whether the data is stored.

According to another aspect of the present invention, there is provided a method of managing data, the method including confirming a second page that is movable on the basis of a first page being displayed, confirming whether data of the second page is stored, and receiving the data according to whether the data is stored.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a process of converting a page according to an exemplary embodiment of the present invention;

FIG. 2 is a block diagram illustrating an apparatus for managing data according to an exemplary embodiment of the present invention;

FIG. 3 is a diagram illustrating pages for each level according to an exemplary embodiment of the present invention;

FIG. 4 is a diagram illustrating a relationship among movable pages according to an exemplary embodiment of the present invention;

FIG. 5 is a diagram illustrating a screen structure of movable pages according to an exemplary embodiment of the present invention;

FIG. 6 is a diagram illustrating a page table according to an exemplary embodiment of the present invention; and

FIG. 7 is a flowchart illustrating a method of managing data according to an exemplary embodiment of the present invention.

### DETAILED DESCRIPTION OF EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention will only be defined by the appended claims. Like identification codes refer to like elements throughout the specification.

The exemplary embodiments of the present invention will now be described more fully with reference to the accompanying drawings.

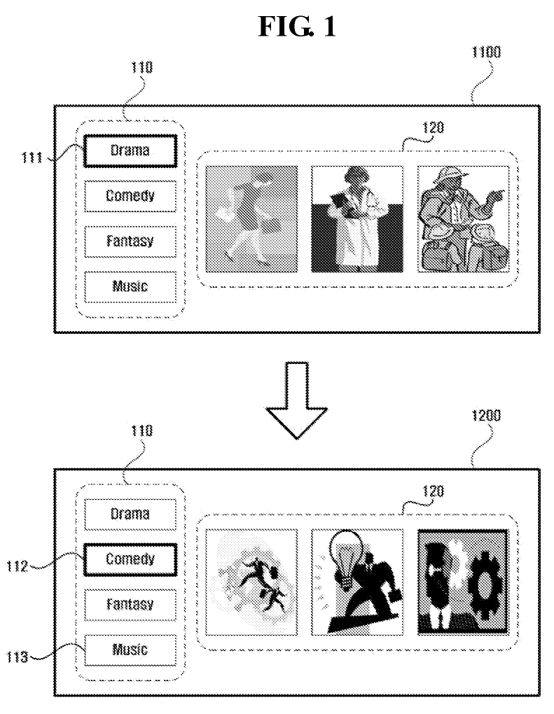

FIG. 1 is a diagram illustrating a process of converting a page according to an exemplary embodiment of the present invention, which illustrates a case where a screen structure of the page is converted according to a selection of a user.

Herein, a page means a one-sided screen that is displayed by a display unit. At least one item, such as a text or an image, may be included in one page. Here, the image includes a still image and a motion picture.

Further, herein, page conversion means that a part of a page or the entire page is changed. That is, among items that constitute a page, at least one item is changed to another item, or all of the items are changed to new items while an arrangement thereof is changed.

FIG. 1 shows an example of a case where a page is divided into a menu region 110 and an image region 120. If one of the menus that are included in the menu region 110 is selected, images that correspond to the selected menu are displayed in the image region 120.

Referring to a first page 1100, it can be understood that a drama menu 111 is selected in the menu region 110, and images corresponding to a drama are displayed in the image region 120. In order to constitute the first page 1100, it is necessary to download text or image information that corresponds to menus of the menu region 110 and images that are being displayed in the image region 120. When the user selects the first page 1100, an apparatus for managing data according to an embodiment of the present invention downloads all information that is needed to constitute the first page 1100. That is, the apparatus for managing data receives page information from a server by using a wireless or wire communication unit.

If a comedy menu 112 in the menu region 110 is subsequently selected by the user, images that correspond to the comedy menu 112 are displayed in the image region 120, as shown in the second page 1200. At this time, the apparatus for managing data needs to download all information needed to constitute the second page 1200 from the server.

As such, if the apparatus for managing data receives necessary information from the server whenever a page is converted, there is a temporal interval at the time of the page conversion. That is, the user should wait until the page is completely converted after the user inputs a page converting command, that is, information on the second page 1200 is completely received from the server.

In order to remove the above-described temporal interval, the apparatus for managing data according to the exemplary embodiment receives and stores the information on the second page 1200 in advance, in a state where the first page 1100 is being displayed. Then, when the user inputs a command to instruct conversion of the first page 1100 into the second page 1200, the apparatus for managing data extracts the information on the second page 1200 that is stored in advance and displays the information on the screen. As a result, it is possible to minimize the temporal interval when converting the first page 1100 into the second page 1200.

In this case, the second page 1200 includes a page that can be converted by a single-input button operation by the user on the basis of the first page 1100. Referring to the first page 1100 shown in FIG. 1, it can be understood that the drama menu 111 is selected as the menu. For example, the user can convert the menu by using a down button or an up button. That is, the user can allow the menu to be converted into the comedy menu 112 from the drama menu 111 by using the down button, or allow the menu to be converted into a music menu 113 from the drama menu 111 by using the up button.

That is, in addition to a page of the comedy menu 112, a page of the music menu 113 may be the second page. The apparatus for managing data receives and stores information of the pages of the comedy menu 112 and the music menu 113, in a state where the first page 1100, that is, the page of the drama menu 111, is being displayed.

In addition, when the user selects the comedy menu 112, the apparatus for managing data extracts and displays information of the page of the comedy menu 112 that is stored in advance, and when the user selects the music menu 113, extracts and displays information of the page of the music menu 113 that is stored in advance.

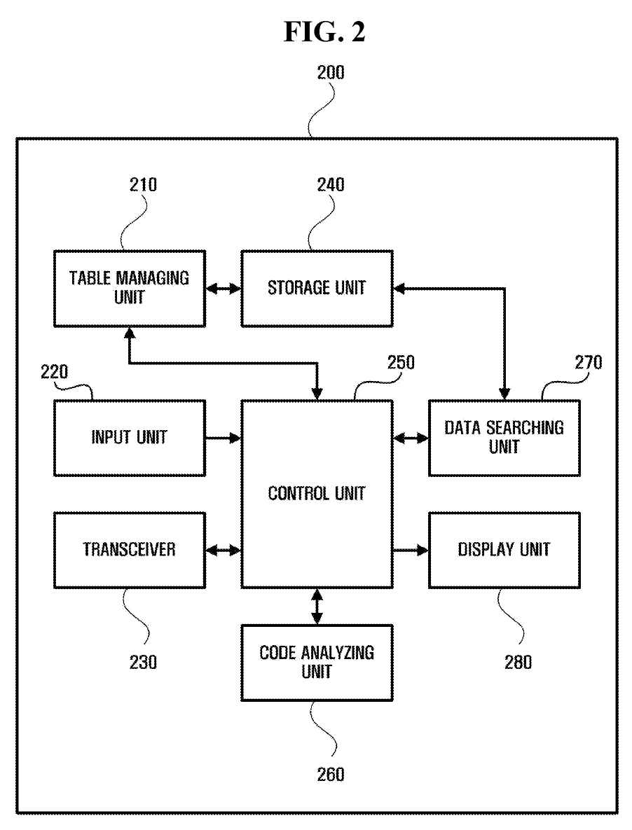

FIG. 2 is a block diagram illustrating an apparatus for managing data according to an exemplary embodiment of the present invention. An apparatus for managing data 200 includes a table managing unit 210, an input unit 220, a transceiver 230, a storage unit 240, a control unit 250, a code analyzing unit 260, a data searching unit 270, and a display unit 280.

The code analyzing unit 260 analyzes a source code of a page that is being displayed (hereinafter, referred to as a first page). The source code includes sizes and locations of items, which constitute the corresponding page, and link commands to make a part of the page or the entire page change. The code analyzing unit 260 extracts the link command and transmits it to the control unit 250.

At this time, the code analyzing unit 260 may analyze an arrangement relationship of items that correspond to the link command and transmit the arrangement relationship of items to the control unit 250.

The control unit 250 confirms a movable page (hereinafter, referred to as a second page) on the basis of the first page. That is, the control unit 250 confirms a page that corresponds to the second page, and a Uniform Resource Locator (URL) of the second page.

At this time, the control unit 250 may use a code analyzed result that is received from the code analyzing unit 260. In general, the link command of the source code includes a URL of a page that is a link subject. The control unit 250 confirms the URL of the second page using the link command that is received from the code analyzing unit 260. Further, the control unit 250 can receive the arrangement relationship of items from the code analyzing unit 260. Therefore, the control unit 250 can confirm the page corresponding to the second page by using the arrangement relationship. That is, it is possible to confirm a page that can be selected by a single-input key operation performed by the user.

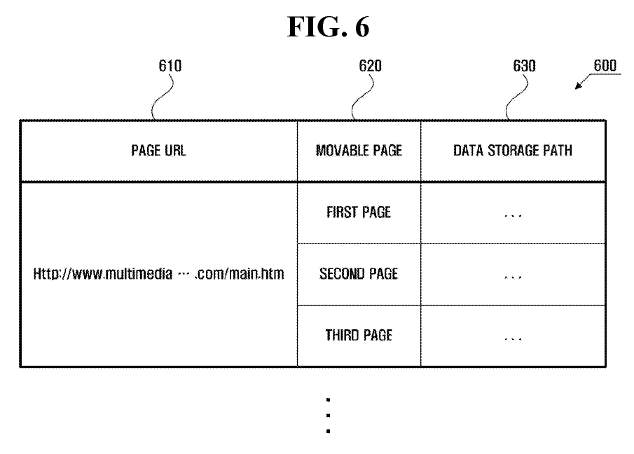

The data searching unit 270 confirms whether data of the second page is stored in the storage unit 240. In this case, the data of the second page may include a source code and image data of the second page. When confirming whether the data of the second page is stored in the storage unit 240, the data searching unit 270 can use a table (hereinafter, referred to as a page table). That is, the data searching unit 270 receives the URL of the second page from the control unit 250 and confirms whether the data of the second page is stored in the storage unit 240 by using the URL of the second page. At this time, the data searching unit 270 does not search all of the data stored in the storage unit 240, but only confirms a page table to confirm whether the data of the second page is stored in the storage unit 240. A detailed description of the page table will be provided below with reference to FIG. 6.

In addition, the data searching unit 270 extracts the data of the second page from the storage unit 240 in accordance with a control command from the control unit 250. When the user inputs a conversion command to instruct conversion of the current page into the second page, the control unit 250 transmits a URL of a specific second page among various candidates of the second page to the data searching unit 270, and the data searching unit 270 extracts data from the storage unit 240 by using the received URL of the second page. Also, when the data is extracted, the data searching unit 270 can use the page table. The page table may include a storage path of the data.

The table managing unit 210 manages the page table. That is, the table managing unit 210 creates and updates the page table. When data of a specific page is received and stored in the storage unit 240, or the usage of the data of the specific page is regarded as being finished and the data is deleted from the storage unit 240, the table managing unit 210 inserts the information of the corresponding page into the page table or deletes the information from the page table.

The storage unit 240 stores the data of the page and the page table. The storage unit 240 is a module that allows input and output of information, such as a hard disc, a flash memory, a compact flash (CF) card, a secure digital (SD) card, a smart media (SM) card, a multimedia (MM) card, or a memory stick. Further, the storage unit 240 may be included in the apparatus for managing data 200 or may be provided in a separate apparatus.

The input unit 220 receives a page converting command input by the user. In order to perform this function, the input unit 220 may include buttons, touch pads or wheels. The user can input a page converting command to instruct conversion of the first page into the second page by using the buttons.

As described above, the second page means a page that can be converted by a single-time key input on the basis of the first page. For example, when the input unit 220 includes buttons, such as up, down, left, and right buttons, a page, which can be specified when the user selects the up button, the down button, the left button or the right button, corresponds to the second page. Accordingly, the control unit 250 regards pages corresponding to the four button inputs as the second pages, and allows the transceiver 230 to receive data for the four pages.

The transceiver 230 receives the data of the second page from the server. A communication method between the transceiver 230 and the server may be a wire communication method, such as Ethernet, USB, IEEE 1394, serial communication, and parallel communication, and may be a wireless communication method, such as infrared communication, Bluetooth, home radio frequency (RF), and a wireless local area network (LAN).

When the storage unit 240 is not included in the apparatus for managing data 200 but in a separate apparatus, the transceiver 230 can transmit or receive the data and the page table to or from the separate apparatus.

The display unit 280 displays the first page or the second page. The display unit 280 is a module having an image display unit that can display an input image signal, such as a cathode ray tube (CRT), a liquid crystal display (LCD), a light-emitting diode (LED), an organic light-emitting diode (OLED), or a plasma display panel (PDP). The display unit 280 displays the image information that is received from the control unit 250, that is, the first page or the second page.

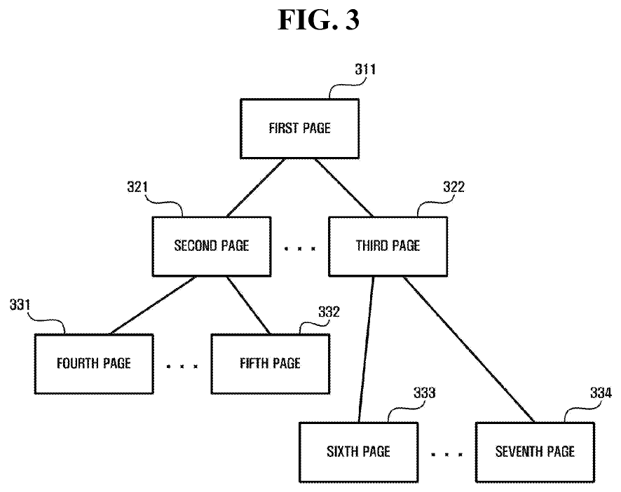

FIG. 3 is a diagram illustrating a page for each level according to an exemplary embodiment of the present invention, which illustrates pages that are divided into three levels. That is, a first page 311 exists in a first level, a second page 321 and a third page 322 exist in a second level, and a fourth page 331, a fifth page 332, a sixth page 333, and a seventh page 334 exist in a third level.

When a currently displayed page is the first page 311 in the first level, the user can perform a page conversion to convert the first page 311 in the first level into the second page 321 or the third page 322 in the second level. When a currently displayed page is the second page 321, the user can perform a page conversion to convert the second page 321 in the second level into the fourth page 331 or the fifth page 332 in the third level, but cannot perform a page conversion to convert the second page 321 into the sixth page 333 or the seventh page 334. This is because the source code of the second page 321 includes link commands to the fourth page 331 and the fifth page 332, but does not include link commands to the sixth page 333 and the seventh page 334.

Similarly, when a currently displayed page is the third page 322, the user can perform a page conversion to convert the third page 322 into the sixth page 333 or the seventh page 334 in the third level, but cannot perform a page conversion to convert the third page 322 into the fourth page 331 or the fifth page 332. This is because the source code of the third page 322 includes link commands to the sixth page 333 and the seventh page 334, but does not include link commands to the fourth page 331 and the fifth page 332.

Specifically, solid lines shown in FIG. 3 indicate a link relationship among pages. That is, convertible pages can be connected to one another by the solid lines, and the directivity of the solid lines may be different according to link commands that are included in the pages. For example, the source code of the first page 311 may include link commands to the second page 321 and the third page 322, but the source codes of the second page 321 and the third page 322 may not include link commands to the first page 311.

As shown in FIG. 3, the pages that can be provided by the server may be hierarchically constructed. The apparatus for managing data 200 can receive and store information of pages included in a level of a previously set step from the server in advance.

For example, when a currently displayed page, that is, the first page is the first page 311, and a page that can be converted by a single-input key operation on the basis of the first page 311, that is, the second page is the second page 321, the apparatus for managing data 200 can receive data of the second page 321 and store it in the storage unit 240 that is included in the apparatus for managing data 200. At this time, a source code of the second page 321 is also included in the data of the second page 321. Even in a state where a currently displayed page is the first page 311, the apparatus for managing data 200 may analyze a source code of the second page 321, receive data of the fourth page 331 or the fifth page 332, which can become the second page on the basis of the second page 321, from the server in advance, and store it in the storage unit 240.

A step of a level in which data of a page is received in advance may be set by the user, or automatically determined according to a network state or attributes of items that are included in the page.

For example, when the network state is superior (i.e., high bandwidth), the apparatus for managing data 200 only receives information of pages that exist in a lower level by one step, and when the network state is inferior (i.e., low bandwidth), the apparatus for managing data 200 receives not only the information of pages existing in a lower level by one step but also information of pages existing in a lower level by two or three steps, and stores the information. Similarly, when a data size of an item is small, the apparatus for managing data 200 only receives information of pages that exist in a lower level by one step, and when the data size of the item is large, the apparatus for managing data 200 can receive not only the information of pages existing in a lower level by one step but also information of pages existing in a lower level by two or three steps, and stores the information.

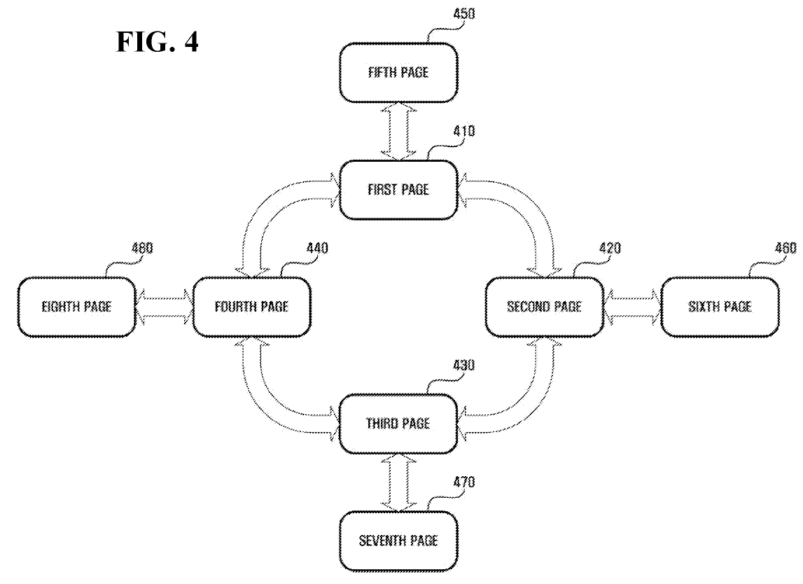

FIG. 4 is a diagram illustrating a relationship among movable pages according to an exemplary embodiment of the present invention, which illustrates a conversion relationship among the pages according to link commands that are included in the individual pages.

As shown in FIG. 4, a source code of the first page 410 includes link commands to instruct conversion of the first page 410 into a second page 420, a fourth page 440, and a fifth page 450, a source code of the second page 420 includes link commands to instruct conversion of the second page 420 into the first page 410, a third page 430, and a sixth page 460, a source code of the third page 430 includes link commands to instruct conversion of the third page 430 into the second page 420, the fourth page 440, and the seventh page 470, and a source code of the fourth page 440 includes link commands to instruct conversion of the fourth page 440 into the first page 410, the third page 430, and the eighth page 480.

Arrows that are shown in FIG. 4 indicate page converting directions. It can be understood that pages, which are connected to one another, can be converted to one another. For example, since the first page 410 and the fifth page 450 are connected to each other, the first page 410 can be converted into the fifth page 450 and the fifth page 450 can be converted into the first page 410.

The pages that are stored in the server may have a hierarchical structure as shown in FIG. 3 and have an organic structure as shown in FIG. 4. That is, as shown in FIG. 4, the pages can be sequentially converted in the order of the first page 410, the second page 420, the third page 430, and the fourth page 440, or can be converted in the order of the fourth page 440, the third page 430, the second page 420, and the first page 410.

For example, when it is set that a currently displayed page is the first page 410 and the apparatus for managing data 200 receives and stores data of pages existing in a lower level by up to two steps, the apparatus for managing data 200 receives and stores data of the second page 420, the fourth page 440, and the fifth page 450 that are pages existing in the first lower level, then receives and stores data of the third page 430 and the sixth page 460 that are pages existing in the second lower level, that is, pages existing in a lower level of the second page 420, and then receives and stores data of the third page 430 and the eighth page 480 that are pages existing in the other second lower level, that is, pages existing in a lower level of the fourth page 440. In this case, the reception of the data of the third page 430 may overlap. However, since the apparatus for managing data 200 determines whether to receive data while referring to a page table, when the data of the third page 430 is already received and stored, the apparatus for managing data 200 may not receive the data of the third page 430 so that the reception of the data of the third page 430 does not overlap.

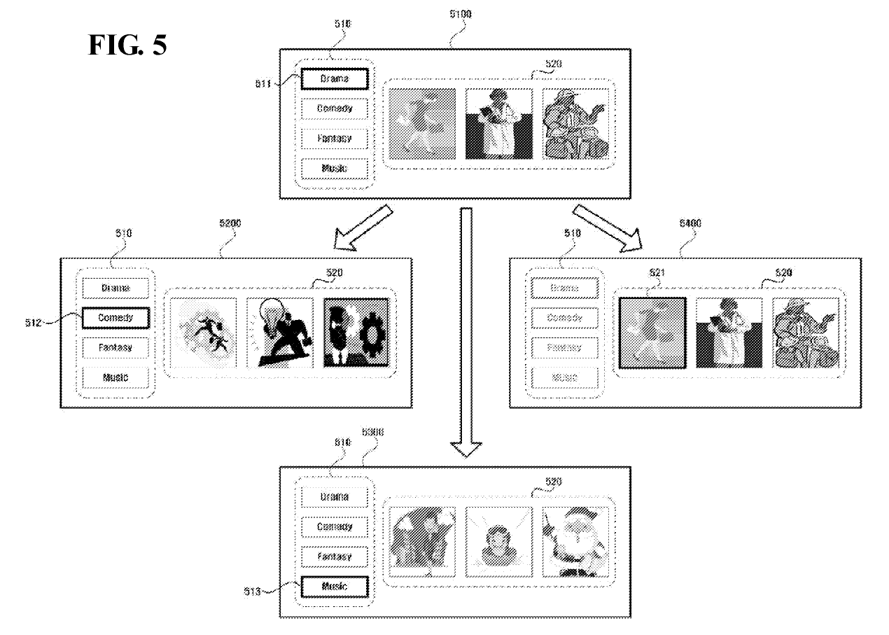

FIG. 5 is a diagram illustrating a screen structure of movable pages according to an exemplary embodiment of the present invention. Here, it is assumed that each page is divided into a menu region 510 and an image region 520, as shown in FIG. 1.

Initially, a drama menu 511 is selected from among menus of the menu region 510 of a first page 5100, and images corresponding to the drama menu 511 are displayed in the image region 520.

In addition, the user can input a page converting command by using the input unit 220. For example, the user can input the page converting command by using arrow buttons. Referring to the menu region 510, it can be understood that the menus are arranged in up and down directions. Accordingly, the user can convert the menu by using up and down buttons among the arrow buttons.

For example, when the user selects the down button, a comedy menu 512 that is located below the drama menu 511 is selected. When the user selects the up button, there is no menu item on the drama menu 511, and as the result, a music menu 513 that is located at a lowest portion of the menu region 510 is selected.

As such, since pages, which can be converted when the user performs a key input operation once, that is, the second pages become a second page 5200 and a third page 5300, the transceiver 230 receives data of the second page 5200 and the third page 5300 from the server. That is, the transceiver 230 receives source codes and image information of the second page 5200 and the third page 5300. In addition, the received data is stored in the storage unit 240, and the table managing unit 210 adds information of the stored page to the page table.

The user may operate a confirmation button in a state where the first page 5100 is being displayed. As a result, the menu region 510 is inactivated and a selection moves to the image region 520. That is, as in the fourth page 5400, a selection moves to one item 521 in the image region 520. Here, since the first page 5100 and the fourth page 5400 use the same items, the fourth page 5400 may not be regarded as the second page. That is, the apparatus for managing data 200 may not perform an operation for receiving the data of the fourth page 5400.

When comparing FIGS. 4 and 5, the first page 410 shown in FIG. 4 corresponds to the first page 5100 shown in FIG. 5, the second page 420 shown in FIG. 4 corresponds to the second page 5200 shown in FIG. 5, the fourth page 440 shown in FIG. 4 corresponds to the third page 5300 shown in FIG. 5, and the fifth page 450 shown in FIG. 4 corresponds to the fourth page 5400 shown in FIG. 5. That is, the first page 5100 can be converted into the second page 5200, the third page 5300, and the fourth page 5400, and the second page 5200, the third page 5300, and the fourth page 5400 can be converted into the first page 5100. However, a page conversion between the second page 5200 and the third page 5300 and a page conversion between the third page 5300 and the fourth page 5400 may not be performed.

FIG. 6 is a diagram illustrating a page table according to an exemplary embodiment of the present invention. A page table 600 includes a page URL field 610, a movable page field 620, and a data storage path field 630.

URLs of pages are included in the page URL field 610. Each page URL is used to specify each page. Each page shown in FIG. 4 is assigned with a unique URL because applying serial numbers to pages cannot specify the pages.

For example, in order to confirm whether data of the second page is stored in the storage unit 240, first, the data searching unit 270 confirms a URL of the second page by using link commands included in the source code of the first page, and confirms a URL of each page that is included in the page URL field 610 of the page table 600. At this time, when the URL of the second page does not exist in the page URL field 610, the data searching unit 270 allows the transceiver 230 to receive data of the corresponding page.

The movable page field 620 includes the URL of the second page. That is, URLs of all pages, which can be converted by a single-input key operation on the basis of the first page, are included in the movable page field 620. Accordingly, when the data searching unit 270 extracts the data of the second page from the storage unit 240, the data searching unit 270 can confirm the URL of the second page from the page table 600 by using the URL of the first page that are being displayed.

The data storage path field 630 includes a storage path of data of the second page. In this case, the storage path may be a physical address or a logical address of the storage unit 240, and when the storage unit 240 is included in a separate apparatus, the storage path may be an address that is assigned to the separate apparatus.

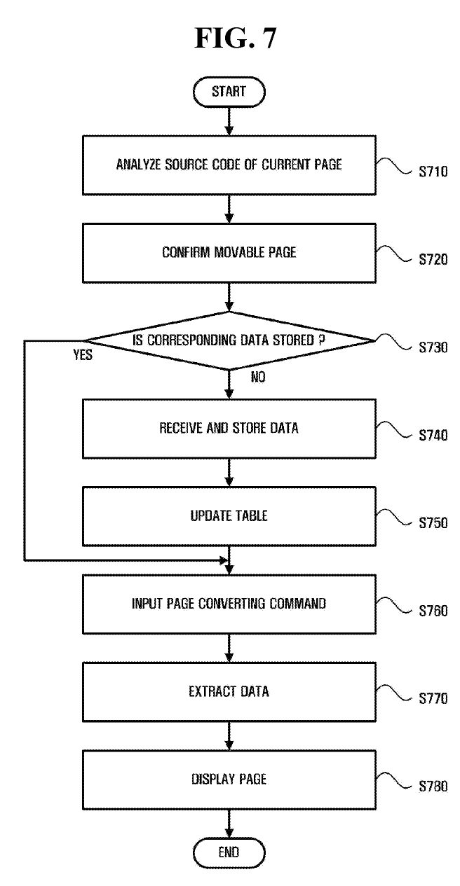

FIG. 7 is a flowchart illustrating a method of managing data according to an embodiment of the present invention. In order to manage the data, first, the code analyzing unit 260 of the apparatus for managing data 200 analyzes a source code of the first page (Operation S710). That is, the code analyzing unit 260 extracts link commands from the source code and analyzes an arrangement relationship of items that correspond to the link commands.

The result that is analyzed by the code analyzing unit 260 is transmitted to the control unit 250, and the control unit 250 confirms a movable page as a second page by using the received result (Operation S720). The result confirmed by the control unit 250 includes the URL of the second page. The URL of the second page is transmitted to the data searching unit 270, and the data searching unit 270 confirms whether the data of the second page is stored in the storage unit 240 (Operation S730).

When confirming whether the data of the second page is stored, the data searching unit 270 can use the page table 600.

As a result of confirming whether the data is stored, when the data is not stored, the transceiver 230 receives the data of the corresponding page from the server, and the storage unit 240 stores the received data (Operation S740).

Then, the table managing unit 210 adds the received and stored information to the page table 600 and updates the page table 600 (Operation S750).

Since one or more second pages may exist, each of the second pages is only one of candidate pages that may move to the apparatus. At this time, when the user inputs the selection command (Operation S760), one second page is specified. Therefore, the data searching unit 270 searches the storage unit 240, and extracts data of the specified second page (Operation S770).

Then, the extracted data is displayed by the display unit 280 (Operation S780). As a result, it is possible to reduce a temporal interval when performing a page conversion from the first page to the second page.

Although exemplary embodiments of the present invention have been described, it will be apparent to those skilled in the art that various modifications and changes may be made thereto without departing from the scope and spirit of the present invention. Therefore, it should be understood that the above exemplary embodiments are not limitative, but illustrative in all aspects.

According to the apparatus and method of managing data according to the embodiments of the present invention, it is possible to reduce an amount of delayed time which occurs when converting a screen by receiving and storing data from a convertible menu screen in advance on the basis of a currently displayed menu screen and constructing the menu screen by using data stored when the corresponding menu screen is selected.

What is claimed is:

1. An apparatus for managing data, the apparatus comprising:
a control unit which confirms that a first page being displayed can be converted into a second page based on the first page;
a data searching unit which determines whether data of the second page is stored; and
a transceiver which receives the data if the data searching unit determines that the data is not stored.

2. The apparatus of claim 1, wherein the first page is converted into the second page by a single-input key operation based on the first page.

3. The apparatus of claim 1, wherein the control unit confirms that the first page can be converted into the second page by referring to a source code of the first page.

4. The apparatus of claim 3, further comprising:
a code analyzing unit which analyzes the source code.

5. The apparatus of claim 1, further comprising:
a table managing unit which manages a table that comprises at least one of an address of the first page, an address of the second page, and a storage path of the data.

6. The apparatus of claim 5, further comprising:
a storage unit which stores the data and the table.

7. The apparatus of claim 1, further comprising:
a display unit which displays the first page or the second page.

8. The apparatus of claim 1, wherein the transceiver receives the data in a state in which the first page is displayed.

9. A method of managing data, the method comprising:
confirming that a first page being displayed can be converted into a second page based on the first page;
determining whether data of the second page is stored; and
receiving the data if it is not determined that the data is not stored.

10. The method of claim 9, wherein the first page is converted into the second page by a single-input key operation based on the first page.

11. The method of claim 9, wherein the confirming the first page can be converted into the second page comprises confirming the first page can be converted into the second page by referring to a source code of the first page.

12. The method of claim 11, further comprising:
analyzing the source code.

13. The method of claim 9, further comprising:
managing a table that comprises at least one of an address of the first page, an address of the second page, and a storage path of the data.

14. The method of claim 9, further comprising:
storing the data.

15. The method of claim 9, further comprising:
displaying the first page or the second page.

16. The method of claim 9, wherein the receiving the data comprising receiving the data in a state in which the first page is displayed.
